(19) United States
(12) Patent Application Publication
(10) Pub. No.: US 2011/0272489 A1
(43) Pub. Date: Nov. 10, 2011

(54) Push-Type Spraying Mineral Water Bottle

(76) Inventor: Chang Ho Chang, Taoyuan City (TW)

(21) Appl. No.: 12/787,545

(22) Filed: May 26, 2010

(30) Foreign Application Priority Data
May 10, 2010 (CN) 201010166865.7

(51) Int. Cl. B05B 9/043

(52) U.S. Cl. 239/329

(57) ABSTRACT

A push type spraying mineral water bottle, including: a mineral water bottle, wherein there is an opening in the bottle and inside the bottle holds the water; a bottle top, wherein the bottle top has vertical through hole, and the bottle top has a liquid-tight manner connection with the opening of the bottle; a sprayer unit fixed on the bottle top by the vertical through hole, and could atomize the mineral water or purified water in the bottle and spray on the air. During the outdoors or in the surrounding environment of heavy dust and hot weather, by means of inverting the mineral water bottle, and turning the nozzle to human body or surroundings, then press the atomization nozzle, to achieve the spraying in the air, so as to reduce the temperature around the human body so that people feel more cool, fresh and comfortable.

### TECHNICAL FIELD

The invention relates to a mineral water bottle, especially refers to a push type spraying mineral water bottle that could be opened for normal drink and could also be used for spraying to reduce the air temperature of the surroundings of human body.

### BACKGROUND ART

The mineral water bottle in current technology, including bottle and bottle top, wherein the bottle has an opening, while outside the opening has screw thread, and inside the bottle top has screw thread, so that the bottle top has a liquid-tight manner connection with the bottle. The mineral water bottle has merits with simple structure, low cost and portable. However, this mineral water bottle has single feature, which unable to meet people's needs.

Contents of the Invention

Aiming at the shortcomings above in existing technology, the invention is to provide a portable multi-functional spraying mineral water bottle for drinking or to adjust the air environment surrounding the human body by spraying.

For achieving the objective above, this invention adopts the following technical solution:

A push type spraying mineral water bottle, including:

A mineral water bottle, wherein there is an opening in the bottle and inside the bottle holds the mineral water or purified water;

A bottle top, wherein the bottle top has vertical through hole, and the bottle top has a liquid-tight manner connection with the opening of the bottle;

A sprayer unit, wherein it is fixed on the bottle top by the vertical through hole, and could atomize the mineral water or purified water in the bottle and spray on the air.

The foresaid sprayer unit including:

An atomization nozzle, wherein on the top of the atomization nozzle has an ergonomic press down notch, on its radial position has a nozzle, and at the bottom has a water inlet;

A spray pipe, wherein the upper end of the spray pipe connects with the atomization nozzle and at the bottom end has a valve corresponding to the pressure cavity;

A pressure cavity, wherein at the bottom end of the pressure cavity has a small caliber of reset spring holding cavity, while the reset spring is located inside the holding cavity, and at the bottom end of the spring holding cavity has a water inlet;

A one-way pressure valve, wherein the upper end of the one-way pressure valve has a liquid tight manner connection with the water inlet of the spray pipe, and the downside has an elastic piston ring that in coordination with the spring holding cavity;

A reset spring, wherein the upper end of the reset spring prop up with the bottom end of the one-way pressure valve, and the bottom end of the reset spring prop up with the downside of the spring holding cavity, while the reset spring is on state of compression.

The foresaid one-way pressure valve has a one-way valve, wherein the one-way valve including:

A upper shield, wherein the upper end of the upper shield has a liquid-tight manner connection with the water inlet of the spray pipe, the side face of the upper shield has through hole, and the bottom end has an opening connects with the center steam pipe;

A spool valve, wherein the spool valve is spheroid and the diameter of the spool valve is greater than the caliber of the center steam pipe;

The center steam pipe, wherein the outer wall of the center steam pipe has an elastic piston ring, and the bottom end of the center steam pipe sustains and connects with the reset spring.

The foresaid bottle top including a main cover and an inner cover, wherein the main cover connects with the inner cover by an elastic interconnecting piece, and the spray unit installed on the main cover; the inner cover corresponding to the front end of the main cover has a block and a trigger piece, while the main cover corresponding to the block of the inner cover has a card slot connects with the block.

By adopting the above structure, a push type spraying mineral water bottle of the invention is able to be drink normally, but also by manually squeeze the atomization nozzle, to realize the spraying or drinking. Meanwhile, during the outdoors or in the surrounding environment of heavy dust and hot weather, the portable air-conditioning unit of the invention, by means of inverting the mineral water bottle, and turning the nozzle to human body or surroundings, then squeezing the bottle, to achieve the spraying in the air, so as to reduce the temperature around the human body, meanwhile to make the settlement by the combination of dust and mist, so that people feel more cool, fresh and comfortable. The invention has merits of simple structure, practical and big market potential.

### DESCRIPTION OF FIGURES

FIG. 1 is the structure drawing of the invention;

FIG. 2 is the structure expansion drawing of the bottle top of the invention;

FIG. 3 is the partial structure drawing of the sprayer unit of the invention.

### MODE OF CARRYING OUT THE INVENTION

Further explanation to the invention is stated below combining with the attached figures.

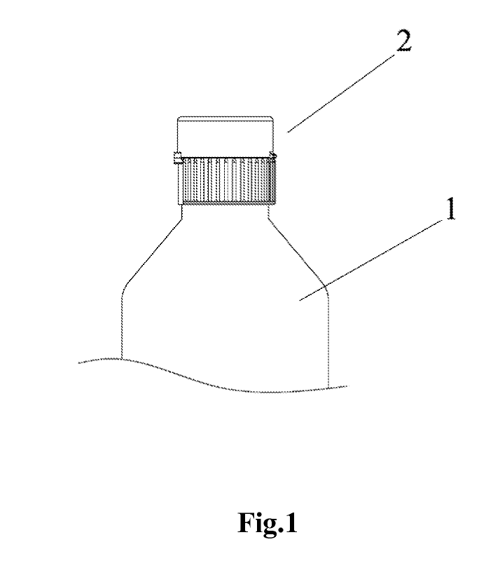

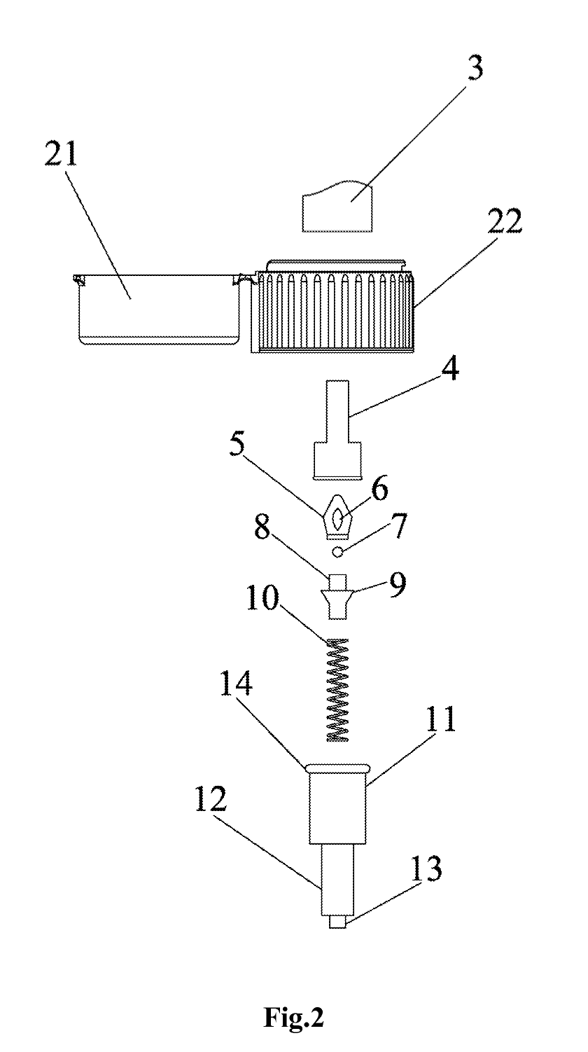

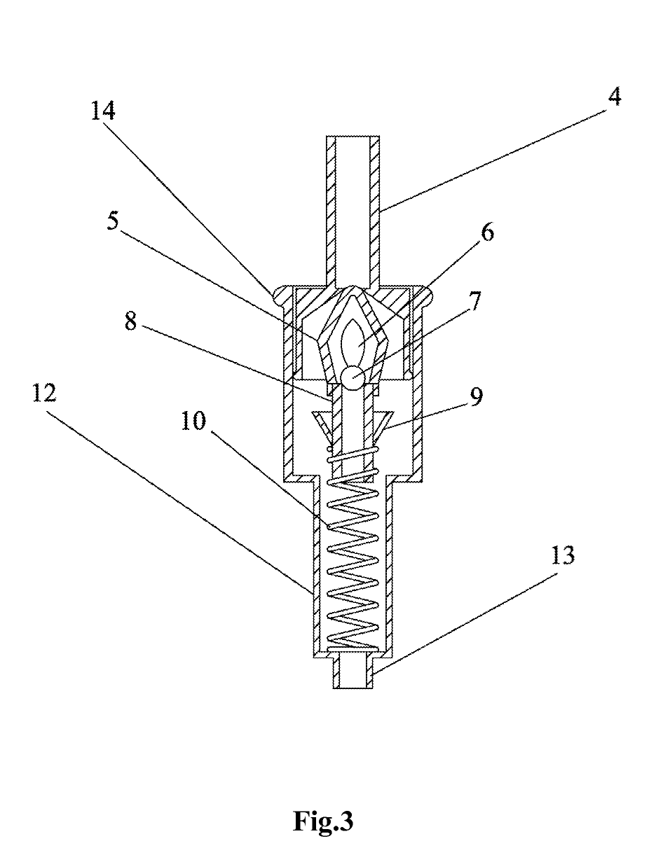

As shown in FIG. 1 to FIG. 3, a push type spraying mineral water bottle, including: a mineral water bottle 1, wherein there is an opening in the bottle and inside the bottle holds the mineral water or purified water; a bottle top 2, wherein the bottle top 2 includes a main cover 22 and an inner cover 21, while the main cover 22 and inner cover 21 connects with the inner cover by an elastic interconnecting piece, and the main cover 22 has a vertical through hole; a sprayer unit, wherein it is fixed on the main cover 22 by the vertical through hole; the inner cover 21 corresponding to the front end of the main cover 22 has a block and a trigger piece, while the main cover 22 corresponding to the block of the inner cover 21 has a card slot connects with the block.

The sprayer unit includes an atomization nozzle 3, a spray pipe 4, a pressure cavity 11, a one-way pressure valve and a reset spring 10. On the top of the atomization nozzle 3 has an ergonomic press down notch, on its radial position has a nozzle, and at the bottom end has a water inlet. The upper end of the spray pipe 4 connects with the atomization nozzle and the bottom end has a valve corresponding to the pressure cavity. The upper end of pressure cavity 11 has an annular convexity 14 in coordination with the main cap body, and at the bottom end of the pressure cavity has a small caliber of reset spring holding cavity 12, while the reset spring 10 is located inside the spring holding cavity 12, and at the bottom end of the spring holding cavity 12 has a water inlet 13. A one-way pressure valve, wherein the upper end of the one-way pressure valve has a liquid tight manner connection with the water inlet of the spray pipe, and the downside has an elastic piston ring that in coordination with the spring holding cavity. The upper end of the reset spring 10 prop up with the bottom end of the one-way pressure valve, and the bottom end of the reset spring prop up with the downside of the spring holding cavity, while the reset spring is on state of compression.

To increase the water inflow, the one-way pressure valve has a one-way valve, wherein the one-way valve includes an upper shield 5, spool valve 7 and a center steam pipe 8; the upper end of the upper shield 5 has a liquid-tight manner connection with the water inlet of the spray pipe 4, the side face of the upper shield has through hole 6, and the bottom end has an opening connects with the center steam pipe 8; the spool valve 7 is spheroid and the diameter of the spool valve is greater than the caliber of the center steam pipe; the outer wall of the center steam pipe 8 has an elastic piston ring 9, and the bottom end of the center steam pipe sustains and connects with the reset spring 10.

In order to save the inversion of the mineral water bottle, a water conduit could be installed on the downside of the water inlet 13.

The working principle of the invention: in actual use, put the mineral water bottle upside down, and press the atomization nozzle to evacuate the air inside the pressure cavity, then release, under the elastic force of the reset spring, the water inside the mineral water bottle is sucked into the pressure cavity. When pressing the atomization nozzle again, the one-way valve move downward, and the elastic piston ring of the outer wall of the one-way valve blocks the upper opening of the spring holding cavity in the downside of the pressure cavity; when the one-way valve keep moving downward, the water pressure of the pressure cavity increasing, and exerting the reacting force on the one-way valve, so as to force it to open the water inlet of the spray pipe, then the high pressure water inside the pressure cavity flow into the spray pipe and spray by the atomization nozzle. And so on, to achieve the spraying in the air, so as to reduce the temperature around the human body, meanwhile to make the settlement by the combination of dust and mist, so that people feel more cool, fresh and comfortable.

What is claimed is:

1. A push type spraying mineral water bottle, including:
A mineral water bottle, wherein there is an opening in the bottle and inside the bottle holds the mineral water or purified water;
A bottle top, wherein the bottle top has vertical through hole, and the bottle top has a liquid-tight manner connection with the opening of the bottle;
A sprayer unit, wherein it is fixed on the bottle top by the vertical through hole, and could atomize the mineral water or purified water in the bottle and spray on the air.

2. A push type spraying mineral water bottle as set forth in claim 1, characterized in that the foresaid sprayer unit including:
An atomization nozzle, wherein on the top of the atomization nozzle has an ergonomic press down notch, on its radial position has a nozzle, and at the bottom has a water inlet;
A spray pipe, wherein the upper end of the spray pipe connects with the atomization nozzle and at the bottom end has a valve corresponding to the pressure cavity;
A pressure cavity, wherein at the bottom end of the pressure cavity has a small caliber of reset spring holding cavity, while the reset spring is located inside the holding cavity, and at the bottom end of the spring holding cavity has a water inlet;
A one-way pressure valve, wherein the upper end of the one-way pressure valve has a liquid tight manner connection with the water inlet of the spray pipe, and the downside has an elastic piston ring that in coordination with the spring holding cavity;
A reset spring, wherein the upper end of the reset spring prop up with the bottom end of the one-way pressure valve, and the bottom end of the reset spring prop up with the downside of the spring holding cavity, while the reset spring is on state of compression.

3. A push type spraying mineral water bottle as set forth in claim 2, characterized in that the foresaid one-way pressure valve has a one-way valve, wherein the one-way valve including:
A upper shield, wherein the upper end of the upper shield has a liquid-tight manner connection with the water inlet of the spray pipe, the side face of the upper shield has a through hole, and the bottom end has an opening connects with the center steam pipe;
A spool valve, wherein the spool valve is spheroid and the diameter of the spool valve is greater than the caliber of the center steam pipe;
The center steam pipe, wherein the outer wall of the center steam pipe has an elastic piston ring, and the bottom end of the center steam pipe sustains and connects with the reset spring.

4. A push type spraying mineral water bottle as set forth in claim 1, characterized in that the foresaid bottle top including a main cover and an inner cover, wherein the main cover connects with the inner cover by an elastic interconnecting piece, and the spray unit installed on the main cover; the inner cover corresponding to the front end of the main cover has a block and a trigger piece, while the main cover corresponding to the block of the inner cover has a card slot connects with the block.
